(19) United States
(12) Patent Application Publication
(10) Pub. No.: US 2019/0338740 A1
(43) Pub. Date: Nov. 7, 2019

(54) FUEL INJECTION DEVICE

(71) Applicant: HITACHI AUTOMOTIVE SYSTEMS, LTD., Hitachinaka-shi, Ibaraki, (JP)

(72) Inventors: Kiyotaka Ogura, Hitachinaka-shi (JP); Takao Miyake, Hitachinaka-shi (JP); Atsushi Hohkita, Hitachinaka-shi (JP)

(73) Assignee: HITACHI AUTOMOTIVE SYSTEMS, LTD., Hitachinaka-shi, Ibaraki, (JP)

(21) Appl. No.: 16/480,909

(22) PCT Filed: Jan. 30, 2018
(86) PCT No.: PCT/JP2018/002839

§ 371 Date: Jul. 25, 2019

(30) Foreign Application Priority Data
Feb. 27, 2017 (JP) 2017-034276

(51) Int. Cl. F02M 61/18

(52) U.S. Cl. CPC F02M 61/1813; F02M 61/1846; F02M 61/1886

(57) ABSTRACT

The present invention is directed to achieving an appropriate L/D of each injection hole in a fuel injection device in which a plurality of injection holes is formed. To achieve the object, provided is a fuel injection device including a valve body and an injection hole forming portion in which a plurality of injection holes is formed on a more downstream side than a seat portion on which the valve body is seated, in which the injection hole forming portion is formed in a manner such that a valve body central axis and a central axis of the injection hole forming portion are horizontally deviated in a vertical cross-sectional surface passing through the valve body central axis.

### TECHNICAL FIELD

The present invention relates to a fuel injection device (fuel injection valve) for an internal combustion engine of an automobile.

### BACKGROUND ART

In an internal combustion engine of an automobile or the like, an electromagnetic fuel injection device driven by an electric signal from an engine control unit is widely used. As for this kind of fuel injection device, there are: a type called port injection in which a fuel injection device is mounted on an intake pipe and indirectly injects fuel into a combustion chamber; and a type called direct injection in which fuel is directly injected into the combustion chamber.

In the latter direct injection type, a spray shape formed by the injected fuel determines combustion performance. Accordingly, optimization of the spray shape is necessary in order to achieve desired combustion performance.

Here, the optimization of the spray shape can also be paraphrased as a spray direction and a spray length.

As a fuel injection device, there is a known fuel injection valve including: a movable valve body; a driving means to drive the valve body; a valve seat which the valve body contacts and separates from; and a plurality of orifices provided on a downstream side of the valve seat, in which the plurality of orifices is formed in different angle directions respectively with respect to a central axis of a nozzle (see PTL 1).

### CITATION LIST

### Patent Literature

PTL 1: JP 2008-101499 A

### SUMMARY OF INVENTION

### Technical Problem

It is known that spray injected from a fuel injection device is injected substantially in an axial direction in which an injection hole is processed. Like a fuel injection valve disclosed in PTL 1, it is demanded to improve processing accuracy of injection hole directions in a fuel injection valve type including a plurality of injection holes (orifices). Additionally, it is also demanded to prevent interference with a combustion chamber size, a piston surface shape, and air control valves (intake valve and exhaust valve) as much as possible and optimally control a length of the spray injected from each of the injection holes in order to reduce generation of an exhaust gas component (particularly, soot and the like that are unburned gas components).

In the fuel injection valve disclosed in PTL 1, there is no description regarding spray lengths of the plurality of injection holes. To optimally control each of the spray lengths, adjustment of an injection hole length/an injecting hole diameter (L/D) of an injecting hole (orifice) is effective, and the L/D is to be a parameter determined by an orifice diameter and a thickness of a nozzle portion forming the orifice. The orifice length can be adjusted by: changing the orifice diameter such that the L/D of each of the orifices becomes substantially the same; or providing a recess larger than the orifice diameter on an orifice outlet side disclosed in PTL 1, and adjusting a depth of the recess.

However, generally, a tip of a nozzle portion in which a plurality of orifices is formed with respect to a central axis of a fuel injection valve has a protruding shape and is axially symmetrical with respect to the central axis. There are many cases where a plurality of spray directions (angles) is often plurally set with respect to the central axis due to a restriction of a mounting position of the fuel injection valve. For this reason, in the case of the orifice diameter disclosed in PTL 1, the fuel injected from the injection holes has a wide spread range because each of the injection holes has a different recess depth. As a result, the fuel adheres to a wall surface of the recess when the recess has a large depth, thereby causing deterioration of exhaust performance such as generation of particularly soot, PN, and the like which are the unburned gas components.

Additionally, in a case where the nozzle portion is not provided with any recess, a flow rate distribution for each injection hole is also determined from the viewpoint of a spray direction of each injection hole and formation of air-fuel mixture in a combustion chamber, and therefore, there may be a case where some orifice L/Ds become long and some orifice L/Ds become conversely shorter than a desired L/D, thereby leading to the above-described deterioration of exhaust performance due to uneven injection beams caused by occurrence of flow separation of a fuel flow generated inside each orifice.

Considering the above, the present invention is directed to achieving an appropriate L/D of each of injection holes in a fuel injection valve where a plurality of injection holes is formed.

### Solution to Problem

To solve the above-described problem, the present invention is characterized in providing “a fuel injection device including a valve body and an injection hole forming portion in which a plurality of injection holes is formed on a more downstream side than a seat portion on which the valve body is seated, in which the injection hole forming portion is formed in a manner such that a valve body central axis and a central axis of the injection hole forming portion are horizontally deviated in a vertical cross-sectional surface passing through the valve body central axis”.

### Advantageous Effects of Invention

According to the present invention, it is possible to achieve an appropriate L/D of each of the injection holes in a fuel injection valve where the plurality of injection holes is formed. Other configurations, functions, and effects of the present invention will be described in detail in the following embodiment.

### BRIEF DESCRIPTION OF DRAWINGS

FIG. 1 is a longitudinal sectional view illustrating an entire structure of a fuel injection device according to an embodiment of the present invention.

FIG. 2 is an axial cross-sectional view of a valve body 41 and a tip portion of an orifice cup 7.

FIG. 3 is an axial cross-sectional view of the valve body 41 and the tip portion of the orifice cup 7 according to an embodiment of the present invention.

FIG. 4 is a view illustrating an injection hole length in a case where a central axis 102 of an injection hole forming portion (orifice cup 71) is horizontally deviated from a valve body central axis 101.

### DESCRIPTION OF EMBODIMENTS

Embodiments of the present invention will be described with reference to the accompanying drawings.

### First Embodiment

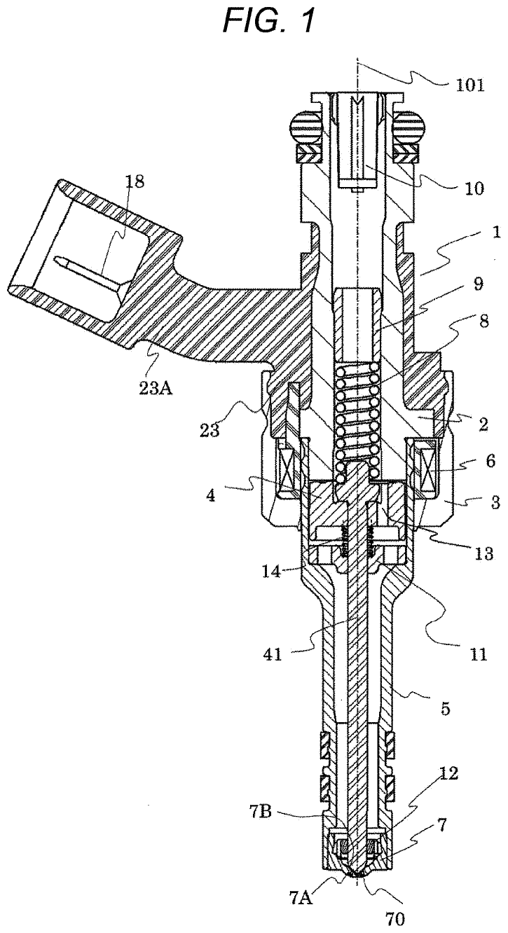

FIG. 1 is a longitudinal sectional view illustrating an entire configuration of a fuel injection device (may also be referred to as fuel injection valve) according to a first embodiment of the present invention. The fuel injection device of the present embodiment is a fuel injection device that directly injects fuel, such as gasoline, into a cylinder (combustion chamber) of an engine.

The fuel injection device 1 has a hollow fixed core 2 (may also be referred to as a magnetic core), a yoke 3 that also serves as a housing, a movable core 4 (may also be referred to as an anchor), and a nozzle body 5. An electromagnetic coil 6 is incorporated on a radially inner side of the yoke 3. The yoke 3 is arranged on a radially outer side and a downstream side, a resin cover 23 is arranged on an upstream side, and a part of the nozzle body 5 is arranged on the radially inner side, thereby covering the electromagnetic coil 6 with a sealing property.

The movable core 4 is movably arranged on a radially inner side of the nozzle body 5. An orifice cup 7 is fixed by press-fitting or welding on the radially inner side of a downstream-side tip (lower side in FIG. 1) of the nozzle body 5. Additionally, a guide member 11 that guides sliding of a valve body 41 is fixed to the radially inner side of the nozzle body 5 and on a downstream side of the movable core 4. A zero spring 14 is arranged on an upper surface of the guide member 11 and biases the movable core 4 in an upstream direction.

Note that sliding of an outer diameter portion of the valve body 41 is also guided by a guide member 12 on a downstream side. The guide member 12 is fixed to a radially inner side of the orifice cup 7 by press-fitting.

A spring 8 that presses the valve body 41 against a seat portion 7B, an adjuster 9 that adjusts spring force of the spring 8, and a filter 10 are incorporated on a radially inner side of the fixed core 2. Since the spring force of the spring 8 is larger than spring force of the zero spring 14, the movable core 4 is biased downward (in a valve-closing direction) via the valve body 41 in a state in which the electromagnetic coil 6 is not energized, and a valve-closed state is kept by a tip of the valve body 41 being pressed against the seat portion 7B.

Fuel that has flown from a fuel inlet at an upper end portion of the fuel injection device 1 of FIG. 1 has foreign matters removed by the filter 10, and flows into the inside of the fuel injection device 1, and the fuel is injected into the cylinder of the engine via an injection hole 70 formed in the orifice cup 7 at a lower end portion. Note that the fuel injection device 1 of the present embodiment is mounted on a common rail (not illustrated), and the common rail is kept at a high pressure (1 MPa or more, for example, 35 MPa to 50 MPa) by a high-pressure fuel pump (not illustrated).

It is desirable that the valve body 41 of the present embodiment be a needle type having a tapered tip or a spherical tip. A conical surface 7A is formed on the radially inner side on the tip side of the orifice cup 7, and the seat portion 7B is formed on this conical surface 7A. The fuel is sealed by a valve body seat portion on the tip side of the valve body 41 contacting the seat portion 7B of the orifice cup 7.

A fuel passage of the fuel injection device 1 includes a passage on the radially inner side of the fixed core 2, a hole 13 axially formed in the movable core 4, a hole 14 axially formed in the guide member 11, a passage on the radially inner side of the nozzle body 5, and a hole axially formed in the guide member 12, and the conical surface 7A including the seat portion 7B. Note that a plurality of the holes 13 formed in the movable core 4, a plurality of the holes 14 axially formed in the guide member 11, and a plurality of holes axially formed in the guide member 12 are formed in a circumferential direction on a horizontal cross-section.

The resin cover 23 is provided with a connector portion 23A to supply exciting current (pulse current) to the electromagnetic coil 6, and a part of a lead terminal insulated by the resin cover 23 is positioned in the connector portion 23A.

When the electromagnetic coil 6 housed in the yoke 3 is excited by an external drive circuit (not illustrated) via the lead terminal 18, the fixed core 2, the yoke 3, and the movable core 4 form a magnetic circuit. A recessed portion recessed in the downstream direction is formed on an upstream side of the movable core 4, and a bottom surface of the recessed portion is engaged with a lower surface of an outer diameter protrusion of the valve body 41. Here, when magnetic attraction force is generated between a facing surface of the fixed core 6 and a facing surface of the movable core 41 by energization of the electromagnetic coil 6, the facing surface of the movable core 41 is attracted to the facing surface of the fixed core 6 because the magnetic attraction force is larger than biasing force of the spring 8 in the downstream direction.

Consequently, the bottom surface of the recessed portion of the movable core 4 and the lower surface of the outer diameter protrusion of the valve body 41 are engaged, thereby driving the valve body 41 in the upstream direction. As a result, the valve body seat portion of the valve body 41 is separated from the seat portion 7B, thereby bringing the valve into an opened state. In this state, the fuel that has flown from the common rail is at the high pressure (1 MPa or more) by the high-pressure fuel pump as described above, and therefore, the fuel inside the fuel injection device 1 is injected from the injection hole 70. A plurality of injection holes 70 is formed in the orifice cup 7.

When the excitation of the electromagnetic coil 6 is turned off after the valve is opened, an upper surface of the outer diameter protrusion of the valve body 41 is biased by the force of the spring 8 in the downstream direction. Consequently, the lower surface of the outer diameter protrusion of the valve body 41 is engaged again with the bottom surface of the recessed portion of the movable core 4, thereby driving the valve body 41 in the downstream direction. As a result, the valve is brought into a closed state because the valve body seat portion of the valve body 41 is pressed against the seat portion 7B.

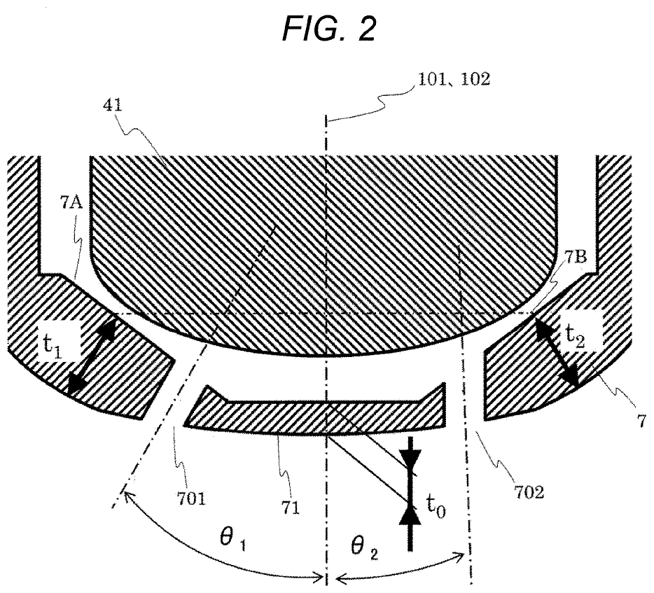

Next, a shape of the orifice cup 7 will be described by using FIG. 2. FIG. 2 illustrates an enlarged view of the valve body 41 and a tip portion of the orifice cup 7. An orifice cup tip protrusion 71 protruding toward the downstream side is formed on the tip side of the orifice cup 7, and the injection holes 70 are formed at the orifice cup tip protrusion 71. Here, note that the plurality of the injection holes 70 is indicated by a first injection hole 701 and a second injection hole 702 respectively. As described above, the valve body 41 may be the needle type or the spherical shape, but here, the needle type valve body 41 is used to illustrate the opened state.

FIG. 2 illustrates an example in which a central axis 101 of the fuel injection device 1 and a central axis 102 of the orifice cup tip protrusion 71 coincide with each other at a substantially same position. The central axis 102 of the orifice cup tip protrusion 71 may be also referred to simply as the central axis 102 of the orifice cup 7. Additionally, the central axis 101 of the fuel injection device 1 may also be referred to as the central axis 101 of the valve body 41.

Here, in a case of defining, as θ1 and θ2, respective angles formed by the first injection hole 701 and the second injection hole 702 with the central axis 101 of the fuel injection device 1, a relation of θ1>θ2 is satisfied. To define thicknesses of the orifice cup in the vicinity of the respective injection holes 701 and 702, respective plate thicknesses can be represented by t1 and t2 when plate thicknesses are illustrated in a form of normal lines from the seat portions 7B provided at upstream portions of the respective injection holes. The orifice cup thicknesses t1 and t2 are defined by the thicknesses in the form of normal lines at the positions of the seat portions 7B of the orifice cup 7 which the valve body seat portion on the tip side of the valve body 41 contacts when the valve is closed. Generally, the plate thicknesses at the upstream portions of the respective injection holes are substantially the same t1≈t2. Additionally, a plate thickness t0 at a center portion of the orifice cup tip portion 71 is set as t0≤t1, t2. It is sufficient that t0 secures a thickness that can withstand fuel pressure applied when the fuel injection device is driven, and it is also sufficient that t0 can secure a space necessary in manufacturing the conical surface 7A, and therefore, the plate thickness t0 of the orifice tip portion is often substantially minimal in the tip protrusion 71.

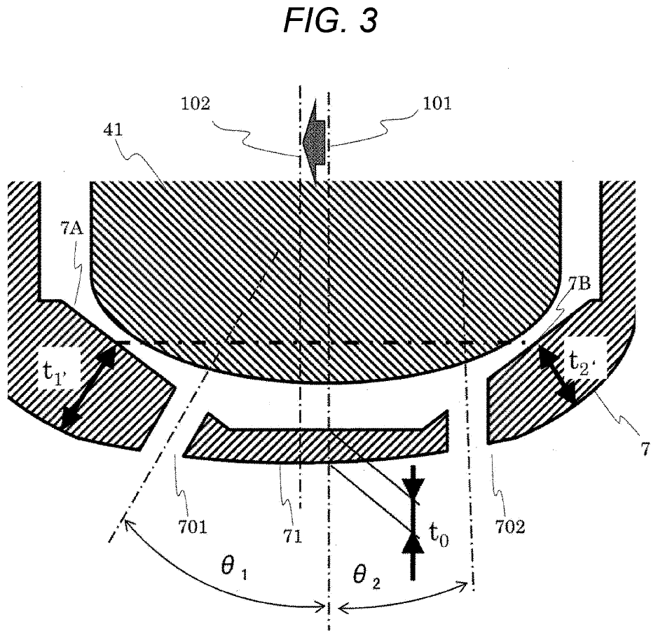

Next, an embodiment of the present invention will be described by using FIG. 3. FIG. 3 illustrates an enlarged view of the valve body 41 and the tip portion of the orifice cup 7 in the present embodiment. There are many cases where a plurality of angles (θ1 and θ2) formed between the central axis 101 of the fuel injection device and the central axes of the respective injection holes are set, and therefore, a difference is caused between flows inside the respective injection holes due to sizes of the angles (θ1 and θ2). Particularly, in a case where the angle (θ2) is relatively small (approximately 10 degrees or less), the fuel flowing from the seat portion tends to flow directly to the injection hole, and therefore, a flow inside the injection hole is uniformly stable.

On the other hand, in a case where the angle (θ1) is relatively large (approximately 25 degrees or more), there may be a case where the fuel flows in a one-sided manner at the time of flowing into the injection hole, and therefore, flow separation is caused inside the injection hole. Accordingly, to suppress such flow separation inside the injection hole, the inventors of the present invention found it possible to suppress the flow separation at an outlet of the injection hole by elongating a length of the injection hole.

A shape of the protrusion is generally axisymmetric with respect to the central axis, but there is a method of changing a plate thickness of each injection hole in order to optimize the above-described plate thickness of each injection hole. However, it is substantially difficult to individually change the plate thicknesses of the plurality of injection holes in terms of a manufacturing cost. A structure of the present embodiment will be described below. As described above, the fuel injection device of the present embodiment includes the valve body 41 and the injection hole forming portion (orifice cup 71) where the plurality of injection holes (701 and 702) is formed on the more downstream side than the seat portion 7B on which the valve body 41 is seated. Additionally, the present embodiment is characterized in that the injection hole forming portion (orifice cup 71) is formed in a manner such that the valve body central axis 101 and the central axis 102 of the injection hole forming portion (orifice cup 71) are horizontally deviated in a vertical cross-sectional surface that passes through the valve body central axis 101 as illustrated in FIG. 3. Note that, in the present embodiment, the injection hole forming portion and a seat member are constituted of the integral orifice cup 71, but the present invention is not limited thereto, and these components may be constituted of separate members individually.

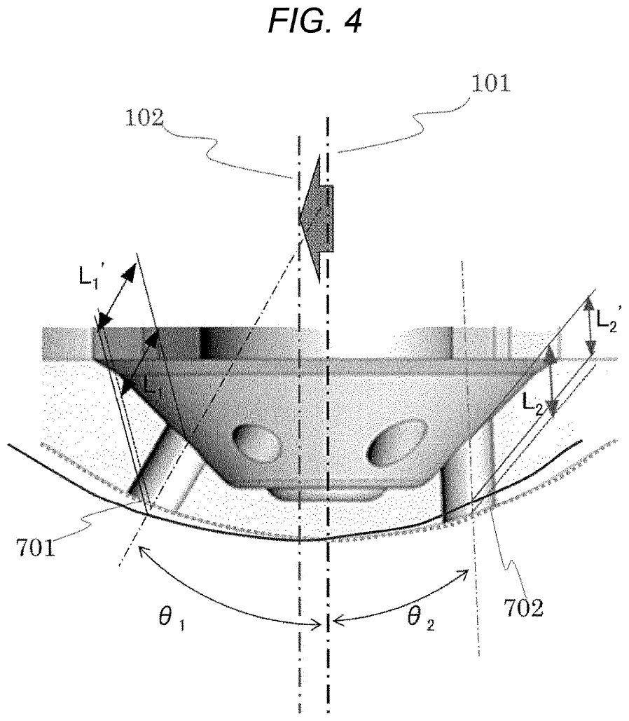

With the above-described method of elongating the length of the injection hole, an L/D of each injection hole can be optimized by optimizing, for each injection hole, a plate thickness of the tip portion, particularly, the protrusion where the injection hole is provided. Thus, as a method of suppressing flow separation of the internal flow inside each injection hole, the length of the injection hole can be adjusted by laterally deviating the orifice tip protrusion 71 from the central axis 101 of the fuel injection device. Here, the seat conical surfaces 7A and the seat portions 7B which form an internal fuel passage are axially symmetric respectively with respect to the central axis 101. The protrusion central axis 102 can be deviated from the central axis 101 of the fuel injection device by a deviated amount of about 0.2 mm to 0.5 mm. Consequently, as illustrated in FIG. 4, the injection hole length of the first injection hole 701 can be elongated from an injection hole length L1 in FIG. 3 to an injection hole length L1′. On the other hand, the injection hole length of the second injection hole 702 can be shortened from an injection hole length L2 in FIG. 3 to an injection hole length L2′.

In the case where the deviation amount between the protrusion central axis 102 and the central axis 101 of the fuel injection device is about 0.2 mm to 0.5 mm, the injection hole length of the first injection hole 701 can be elongated, for example, the length L1′ is elongated to L1, that is, about from 0.2 mm to 0.35 mm. On the other hand, the injection hole length of the second injection hole 702 can be shortened, for example, the length L2 is shortened to L2′, that is, about from 0.2 mm to 0.1 mm. Note that, as illustrated in FIG. 4, the central axis 102 of the injection hole forming portion (orifice cup 71) is deviated, but a position of forming the injection hole is not changed, and therefore, injection hole inlet surfaces are formed at the same position in the present embodiment.

Additionally, the fuel injection device of the present embodiment includes: the valve body 41; the first injection hole 701 which is formed on the more downstream side than the seat portion 7B on which the valve body 41 is seated and has the first angle θ1 as an angle formed between the valve body central axis 101 and the axis of the injection hole; and the second injection hole 702 having the second angle θ2 as an angle formed between the valve body central axis 101 and the axis of the injection hole, in which the second angle θ2 is smaller than the first angle θ1. Additionally, in the vertical cross-sectional surface which is illustrated in FIG. 3 and includes the first injection hole 701 and the second injection hole 702, the injection hole forming portion (orifice cup 71) is formed in a manner such that a thickness t1′ of the injection hole forming portion (orifice cup 71) at an intersection with the seat surface 7A horizontally drawn toward the upstream side of the first injection hole 701 from a base point of the valve body central axis 101 becomes different from a thickness t2′ of the injection hole forming portion (orifice cup 71) at an intersection with the seat surface 7A horizontally drawn toward the upstream side of the second injection hole 702 from the mentioned base point of the valve body central axis 101. Note that the base point is determined so as to become a position same as the seat portion 7B.

Consequently, in the vertical cross-sectional surface which is illustrated in FIG. 3 and includes the first injection hole 701 and the second injection hole 702, the injection hole forming portion (orifice cup 71) is formed in a manner such that the thickness t1′ of the injection hole forming portion (orifice cup 71) at the intersection with the seat surface 7A horizontally drawn toward the upstream side of the first injection hole 701 from the base point of the valve body central axis 101 becomes larger than the thickness t2′ of the injection hole forming portion (orifice cup 71) at the intersection with the seat surface 7A horizontally drawn toward the upstream side of the second injection hole 702 from the base point of the valve body central axis 101.

Next, in a case where the angle θ1 formed by the first injection holes 701 is larger than the angle θ2 formed by the second injection holes 702, when the plate thicknesses of the seat member in a normal line direction from the seat portion 7B are set as t1′ and t2′, the thicknesses can be set differently set such as t1′>t2′ by deviating the protrusion central axis toward the θ1 side. Consequently, the injection hole length is elongated in the injection hole 1, and the injection hole length can be set short in the injection hole 2.

Additionally, in the present embodiment, as illustrated in FIG. 3, the first injection hole 701 and the second injection hole 702 are formed in a manner such that the respective injection hole lengths become different. In other words, as described above, the valve body central axis 101 and the central axis 102 of the injection hole forming portion (orifice cup 71) are horizontally deviated in the vertical cross-sectional surface which is illustrated in FIG. 3 and passes through the valve body central axis 101. Consequently, the injection hole formation part (orifice cup 71) is formed in a manner such that the respective injection hole lengths of the first injection hole 701 and the second injection hole 702 become different.

Note that, in the vertical cross-sectional surface which is illustrated in FIG. 3 and passes through the valve body central axis 101, the injection hole forming portion (orifice cup 71) are formed in a manner such that the central axis 102 of the injection hole forming portion (orifice cup 71) is deviated toward the first injection hole 701 side from the valve body central axis 101.

Since the injection hole forming portion (orifice cup 71) is formed in the manner such that the central axis 102 of the injection hole forming portion (orifice cup 71) is deviated toward the first injection hole 701 side from the valve body central axis 101 in the vertical cross-sectional surface which is illustrated in FIG. 3 and passes through the valve body central axis 101, the injection hole length L1′ of the first injection hole 701 becomes longer than the injection hole length L2′ of the second injection hole 702 in the vertical cross-sectional surface including the first injection hole 701 and the second injection hole 702. Note that each injection hole length is defined by a length of a straight line connecting a center of the inlet surface of the injection hole and a center of an outlet surface.

Thus, in the case where the angle θ1 formed by the first injection hole 701 and the angle θ2 formed by the second injection hole 702 are set at the different angles, the injection hole lengths can also be set different respectively. When the relation of θ1>θ2 is satisfied, the injection hole lengths also have the same relation, in which it is also desirable that the injection hole length L1 of the first injection hole 701 be set longer than the injection hole length L2 of the second injection hole 702

That is to say, flow separation tends to occur in a flow inside the injecting hole of the first injection hole 701 having the larger θ, and spray beams become uneven. Accordingly, according to the present embodiment, the internal flow separation can be suppressed by elongating the injection hole length L1′ of the first injection hole 701 because of a rectifying effect.

As described above, it is possible to deviate the central axis of the orifice tip protrusion as a means to elongate an injection hole length on a piston side. As a deviating direction, a plate thickness of a portion forming an injection hole from the seat portion can be increased by deviating, with respect to the central axis of the fuel injection device, the central axis of the protrusion in a direction desired to elongate the injection hole length, and in a case of setting the same injection hole diameter, an L/D can be increased.

On the other hand, as for the angle formed by the injection hole on the opposite side, a plate thickness of a portion forming the injection hole is reduced from the seat portion, but in a case where the angle formed between the fuel injection device and the injection hole is small as described above, a flow into the injection hole becomes often uniform, and internal flow separation hardly occurs. As a result, influence of the flow separation inside the injection hole caused by the reduced plate thickness is reduced.

From the above, the flow separation of the flow inside the injection hole can be suppressed by deviating the central axis of the injection hole orifice cup tip protrusion toward an injection hole side in which the angle formed between the central axis of the fuel injection device and the central axis of the injection hole is large.

The fuel injection device of the present embodiment is used for side injection and mounted on an internal combustion engine from the horizontal direction. In other words, the present embodiment is effective in a case where a direct injection type, particularly, a side injection system in which injection holes of the fuel injection device are mounted between the piston and an intake interval. In this case, spray patterns aiming at an ignition plug side, the piston side, and an intermediate portion between the ignition plug and the piston are major streams. As characteristics of each injection hole, an angle formed between the fuel injection device and the injection hole on the ignition plug side is often set small equivalent to 02, and an angle formed by an injection hole on the piston side is often set large equivalent to θ1. Therefore, the flow separation of the internal flow can be reduced by elongating the injection hole length of the first injection hole 701 on the piston side.

Here, there is also a case where it is desirable that the injection hole forming portion (orifice cup 71) be formed in a manner such that the central axis 102 of the injection hole forming portion (orifice cup 71) be deviated toward the second injection hole 702 side from the valve body central axis 101 in the vertical cross-sectional surface which is illustrated in FIG. 3 and passes through the valve body central axis 101.

This is the direct injection type, particularly, the case of the direct injection type in which an injection hole tip of the fuel injection device is mounted near the ignition plug.

In this case, the first injection hole 701 is often set to be oriented to the ignition plug side. The reason is that, from the viewpoint of air-fuel mixture formation inside the cylinder, homogeneity is more improved in a case of setting, like the second injection hole 702, spray toward the piston oriented downward in order to prevent fuel adhesion to an intake valve or an exhaust valve.

Additionally, from the viewpoint of a combustion property, it is necessary to provide short spray in the lateral direction from the fuel injection device because it is necessary to inject dense air-fuel mixture required for ignition in a periphery of the ignition plug. Therefore, it is desirable that the angle θ1 formed by the first injection holes 701 be set large and additionally the plate thickness be set small in order to further shorten the injection hole length. In other words, it is desirable that a relation be opposite from FIG. 3 and become t1′<t2′.

In the case of the direct injection type in which the fuel is directly injected into the cylinder, particularly in the case of the side injection type in which the injection holes of the fuel injection device are mounted between the piston and the intake interval, the spray patterns aiming at the ignition plug side, the piston side, and the intermediate portion between the ignition plug and the piston are major streams. As the characteristics of the respective injection holes, an angle formed between the fuel injection device and each injection hole on the ignition plug side is often small, and an angle formed by an injection hole on the piston side is often large. Therefore, flow separation of the internal flow can be reduced by elongating the injection hole length on the piston side.

As a means to elongate the injection hole length on the piston side, it is possible to deviate the central axis of the orifice tip protrusion. As the deviating direction, the plate thickness of the portion forming an injection hole is increased from the seat portion by deviating, with respect to the central axis of the fuel injection device, the central axis of the protrusion in a direction desired to elongate the injection hole length, and in a case of setting the same injection hole diameter, the L/D can be increased.

On the other hand, as for the angle formed by the injection hole on the opposite side, the plate thickness of the portion forming the injection hole is reduced from the seat portion, but in the case where the angle formed between the fuel injection device and the injection hole is small as described above, the flow into the injection hole becomes often uniform, and internal flow separation hardly occurs. As a result, influence of the flow separation inside the injection hole caused by the reduced plate thickness is reduced.

From the above, the flow separation of the flow inside the injection hole can be suppressed by deviating the central axis of the injection hole orifice cup tip protrusion toward the injection hole side in which the angle formed between the central axis of the fuel injection device and the central axis of the injection hole is large.

### REFERENCE SIGNS LIST

1 injection valve main body
2 fixed core
3 yoke
4 movable core
5 nozzle body
6 electromagnetic coil
7 orifice cup
7A conical surface
7B seat portion
8 spring
81 to 86 recess
9 adjuster
10 filter
11, 12 guide member
13 plurality of holes provided in movable core
18 lead terminal
23 resin cover
41 valve body
90 injection hole (orifice)
701 first injection hole
702 second injection hole
71 injection hole tip protrusion
101 central axis of fuel injection device
102 central axis of injection hole tip protrusion

1. A fuel injection device comprising: a valve body; and an injection hole forming portion in which a plurality of injection holes is formed on a more downstream side than a seat portion on which the valve body is seated,
wherein the injection hole forming portion is formed in a manner such that a valve body central axis and a central axis of the injection hole forming portion are horizontally deviated in a vertical cross-sectional surface passing through the valve body central axis.

2. A fuel injection device comprising: a valve body; a first injection hole formed on a more downstream side than a seat portion on which the valve body is seated and having a first angle θ₁ as an angle formed between a valve body central axis and an injection hole axis; and a second injection hole having a second angle θ₂ as an angle formed between the valve body central axis and an injection hole axis, the second angle θ₂ being smaller than the first angle θ₁,
wherein the injection hole forming portion is formed in a manner such that a thickness of the injection hole forming portion at an intersection of a seat surface and a virtual line horizontally drawn toward an upstream side of the first injection hole from a base point of the valve body central axis becomes different from a thickness of the injection hole forming portion at an intersection of a seat surface and a virtual line horizontally drawn toward an upstream side of the second injection hole from the base point of the valve body central axis in a vertical cross-sectional surface including the first injection hole and the second injection hole.

3. A fuel injection device comprising: a valve body; an injection hole forming portion where a seat portion on which the valve body is seated is formed; a first injection hole formed on a more downstream side than the seat portion and having a first angle θ₁ as an angle formed between a valve body axis and an injection hole axis; and a second injection hole having a second angle θ₂ as an angle formed between the valve body axis and an injection hole axis, the second angle θ₂ being smaller than the first angle θ₁,
wherein an injection hole length of the first injection hole differs from an injection hole length of the second injection hole.

4. The fuel injection device according to claim 1, comprising:
a first injection hole formed on a more downstream side than the seat portion and having a first angle θ₁ as an angle formed between a valve body axis and an injection hole axis; and a second injection hole having a second angle θ₂ as an angle formed between the valve body axis and an injection hole axis, the second angle θ₂ being smaller than the first angle θ₁, wherein since the valve body central axis is horizontally deviated from the central axis of the injection hole forming portion in the vertical cross-sectional surface passing through the valve body central axis, the injection hole forming portion is formed in a manner such that a thickness of the injection hole forming portion at an intersection of a seat surface and a virtual line horizontally drawn toward an upstream side of the first injection hole from a base point of a valve body central axis becomes different from a thickness of the injection hole forming portion at an intersection of a seat surface and a virtual line horizontally drawn toward an upstream side of the second injection hole from the base point of the valve body central axis in the vertical cross-sectional surface including the first injection hole and the second injection hole.

5. The fuel injection device according to claim 1, comprising:
a first injection hole formed on a more downstream side than the seat portion and having a first angle θ₁ as an angle formed between a valve body axis and an injection hole axis; and a second injection hole having a second angle θ₂ as an angle formed between the valve body axis and an injection hole axis, the second angle θ₂ being smaller than the first angle θ₁, wherein since the valve body central axis is horizontally deviated from the central axis of the injection hole forming portion in the vertical cross-sectional surface passing through the valve body central axis, the injection hole forming portion is formed in a manner such that injection hole lengths of the first injection hole and the second injection hole become different respectively.

6. The fuel injection device according to claim 1, comprising:
a first injection hole formed on a more downstream side than the seat portion and having a first angle θ₁ as an angle formed between a valve body axis and an injection hole axis; and a second injection hole having a second angle θ₂ as an angle formed between the valve body axis and an injection hole axis, the second angle θ₂ being smaller than the first angle θ₁,
wherein the injection hole forming portion is formed in a manner such that the central axis of the injection hole forming portion is deviated toward the first injection hole side from the valve body central axis in the vertical cross-sectional surface passing through the valve body central axis.

7. The fuel injection device according to claim 6,
wherein the fuel injection device is for side fuel injection and is mounted on an internal combustion engine from a horizontal direction.

8. The fuel injection device according to claim 1, comprising:
a first injection hole formed on a more downstream side than the seat portion and having a first angle θ₁ as an angle formed between a valve body axis and an injection hole axis; and a second injection hole having a second angle θ₂ as an angle formed between the valve body axis and an injection hole axis, the second angle θ₂ being smaller than the first angle θ₁,
wherein the injection hole forming portion is formed in a manner such that the central axis of the injection hole forming portion is deviated toward the second injection hole side from the valve body central axis in the vertical cross-sectional surface passing through the valve body central axis.

9. The fuel injection device according to claim 8,
wherein the fuel injection device is for direct fuel injection and is mounted on an internal combustion engine from a vertical direction.

10. The fuel injection device according to claim 4,
wherein since the injection hole forming portion is formed in the manner such that the central axis of the injection hole forming portion is deviated toward the first injection hole side from the valve body central axis in the vertical cross-sectional surface passing through the valve body central axis, the injection hole forming portion is formed in a manner such that the thickness of the injection hole forming portion at the intersection of the seat surface and the virtual line horizontally drawn toward the upstream side of the first injection hole from the base point of the valve body central axis becomes larger than the thickness of the injection hole forming portion at the intersection of the seat surface and the virtual line horizontally drawn toward the upstream side of the second injection hole from the base point of the valve body central axis in the vertical cross-sectional surface including the first injection hole and the second injection hole.

11. The fuel injection device according to claim 4,
wherein since the injection hole forming portion is formed in the manner such that the central axis of the injection hole forming portion is deviated toward the first injection hole side from the valve body central axis in the vertical cross-sectional surface passing through the valve body central axis, an injection hole length of the first injection hole is made longer than an injection hole length of the second injection hole in the vertical cross-sectional surface including the first injection hole and the second injection hole.
